(19) United States
(12) Patent Application Publication
(10) Pub. No.: US 2026/0307099 A1
(43) Pub. Date: Oct. 8, 2026

(54) Glue Dispenser System and Method of Use

(71) Applicant: Kody Burress, Amarillo, TX (US)

(72) Inventor: Kody Burress, Amarillo, TX (US)

(21) Appl. No.: 19/550,060

(22) Filed: Feb. 25, 2026

Related U.S. Application Data
(60) Provisional application No. 63/762,856, filed on Feb. 25, 2025.

(51) Int. Cl. B05C 17/005

(52) U.S. Cl. CPC B05C 17/0053

(57) ABSTRACT

A mounted glue dispenser is disclosed that comprises a mounting structure configured to support the system relative to a support surface. A glue dispenser body pivotably coupled to the mounting structure, the glue dispenser body is disclosed that comprises a heating element configured to melt adhesive material, a nozzle positioned to dispense melted adhesive material, and an internal cavity extending from a rear portion to the nozzle for receiving a solid adhesive stick. An actuator member operatively coupled to the glue dispenser body and extending beyond the nozzle, the actuator member configured to provide mechanical advantage for actuating the glue dispenser body. An advancement mechanism operatively associated with the glue dispenser body and configured to advance the solid adhesive stick through the [internal channel] toward the heating element in response to actuation of the actuator member.

### CROSS-REFERENCE TO RELATED APPLICATIONS

This application claims the benefit of U.S. Provisional Patent Application No. 63/762,856, filed on Feb. 25, 2025, titled “Glue Dispenser System and Method of Use,” the entire disclosure of which is hereby incorporated by reference herein for all purposes.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

The present invention relates to the field of adhesive application and dispenser systems, particularly to glue guns and their associated mounts, stands, and automated feeding mechanisms. Typical handheld glue guns are limited by the user's need to support and manipulate the tool during operation. This can lead to user fatigue, inconsistent glue application, and challenges when bonding intricate or delicate workpieces.

A significant advantage of the disclosed system is the provision of multiple mounting configurations—including wall mount, vertical overhead mount, freestanding table mount, and fully articulated arm attachments. These configurations allow hands-free or one-handed operation for the user. By incorporating manual or motorized feeding of glue sticks, the user can tailor the dispensing process to particular tasks, from detailed arts-and-crafts projects to professional-grade applications such as plastic welding and paintless dent repair.

Additionally, the invention contemplates a holster-style accessory that enables conventional glue guns to be used in the advanced mounting and feeding frameworks described herein. Users can thus repurpose an existing glue gun, enjoying consistent glue flow rates, optional electronic speed/temperature control, and upgraded safety features without discarding prior equipment. Integrating features such as a rechargeable power source, Bluetooth connectivity, and removable data/control modules further enhances versatility by enabling specialized use cases and future expansions. Consequently, the invention addresses longstanding challenges—namely ergonomics, repeatability, and adaptability—while offering a platform that can evolve through modular add-ons. The inventors are not currently aware of any specific prior art references that fully address the breadth of these mounting options or the seamless integration of manual, motorized, and wireless control systems for glue dispensing.

Although the device incorporates a glue-dispensing action, concerns regarding similarities to 3D printer dispensing mechanisms have been considered and evaluated. As of the filing of this application, the invention has not been publicly disclosed, offered for sale, or otherwise made available. The closest known commercial products are wireless and wired hot glue guns. Several prior art references—such as U.S. Pat. Nos. 5,881,924; 5,881,912; 5,881,923; 6,041,972; 7,520,408; 6,065,888; 6,891,130; 5,026,188; 6,202,892; and US 2024/157393—have been reviewed but are not believed to anticipate or render obvious the disclosed invention.

### BRIEF SUMMARY OF THE INVENTION

A mounted glue dispenser 300 is disclosed that comprises a vertical post 302 configured to support said system relative to a support surface. A body 310 pivotably coupled to said vertical post 302, said body 310 is disclosed that comprises a heating element 110 configured to melt adhesive material, a nozzle 312 positioned to dispense melted adhesive material, and an internal cavity 700 extending from a rear portion to said nozzle 312 for receiving a glue stick 102. An pushing lever 314 operatively coupled to said body 310 and extending beyond said nozzle 312, said pushing lever 314 configured to provide mechanical advantage for actuating said body 310. An pushing bracket 308 operatively associated with said body 310 and configured to advance said glue stick 102 through said internal channel toward said heating element 110 in response to actuation of said pushing lever 314.

A method of use of dispensing adhesive material using the mounted glue dispenser 300 is disclosed that comprises mounting the vertical post 302 to a support surface. Positioning the body 310 having the heating element 110 and the nozzle 312, where said body 310 is pivotably coupled to said vertical post 302. Inserting the glue stick 102 into the internal cavity 700 of said body 310. Applying force to the pushing lever 314 extending from said body 310. Pivoting said body 310 relative to said vertical post 302 in response to said force applied to said pushing lever 314. Advancing said glue stick 102 through said internal channel toward said heating element 110 using the pushing bracket 308 actuated by movement of said pushing lever 314. Melting a portion of said glue stick 102 with said heating element 110. Dispensing melted adhesive material through said nozzle 312 onto a target surface.

The mounted glue dispenser 300 is disclosed that comprises the vertical post 302 configured to interface with a support surface. The body 310 coupled to said vertical post 302, said body 310 is disclosed that comprises the heating element 110 for melting solid adhesive material, the nozzle 312 in fluid communication with said heating element 110, and a feed pathway extending from a receiving end to said heating element 110. The pushing lever 314 mechanically coupled to said body 310 and positioned to extend beyond said nozzle 312, said pushing lever 314 configured to impart movement to said body 310 relative to said vertical post 302. the pushing bracket 308 operatively coupled to said body 310 and configured to advance solid adhesive material through said feed pathway toward said heating element 110 in coordination with actuation of said pushing lever 314.

### BRIEF DESCRIPTION OF THE SEVERAL VIEWS OF THE DRAWING

FIGS. 1-2 illustrate a prior art perspective view of a glue gun system 100.

FIG. 2 illustrates another prior art perspective view of said glue gun system 100.

FIG. 3 illustrates a mounted glue dispenser 300 in a horizontal mount configuration 240.

FIG. 4 illustrates an elevated side view of said mounted glue dispenser 300.

FIG. 5 illustrates another elevated side view of said mounted glue dispenser 300, showing the system reset and prepared for subsequent operation.

FIG. 6 illustrates a perspective overview of said mounted glue dispenser 300 in a vertical mount configuration 600.

FIG. 7 illustrates a perspective view of said mounted glue dispenser 300 with a body shell 602 in a disassembled or broken-apart state.

FIG. 8 illustrates an elevated side view of said mounted glue dispenser 300 and said vertical mount configuration 600.

FIGS. 9A and 9B illustrate an elevated side view of said mounted glue dispenser 300, said vertical mount configuration 600, and a cross-sectional front view thereof.

FIG. 10 illustrates said mounted glue dispenser 300 in said vertical mount configuration 600 with first side 604a removed to expose an internal cavity 700.

FIG. 11 illustrates a perspective overview of a pushing bracket 308.

FIG. 12 illustrates a perspective lower view of said pushing bracket 308.

FIG. 13 illustrates an elevated top view of said pushing bracket 308.

FIG. 14 illustrates an elevated side view of an electric switch configuration 1400 of said mounted glue dispenser 300.

FIG. 15 illustrates said electric switch configuration 1400 in an activated configuration 1500.

FIGS. 16A, 16B, and 16C illustrate three elevated views of portions of said electric switch configuration 1400 integrated into said mounted glue dispenser 300.

FIGS. 16B and 16C depict variations where said body shell 602, a top mount 606, and a pushing lever 314 are removed or partially cut away to highlight interior features.

FIGS. 17A, 17B, and 17C illustrate three elevated views of said top mount 606.

FIGS. 17D, 17E, and 17F illustrate three elevated views of a mounting sleeve 1710.

FIGS. 18A, 18B, 18C, and 18D illustrate various views of said top mount 606 inserted into portions of said mounting sleeve 1710, as well as an overview of said mounting sleeve 1710.

FIG. 19 illustrates a side view of a holster configuration 1900 of said mounted glue dispenser 300.

FIGS. 20A and 20B illustrate several views of a barbed clutch wheel assembly 2000.

FIG. 21 illustrates a hand-drawn schematic of a manual advancement bracket 2100 of said mounted glue dispenser 300.

FIGS. 22A, 22B, 22C, and 22D illustrate an alternative configuration of said top mount 606 featuring a geared mount 2200.

FIGS. 23A and 23B illustrate an elevated side view and a front view, respectively, of an electric switch configuration 2300 of said mounted glue dispenser 300.

FIGS. 24A and 24B illustrate a standing version 2400 of said mounted glue dispenser 300 with a base 2402.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system-and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

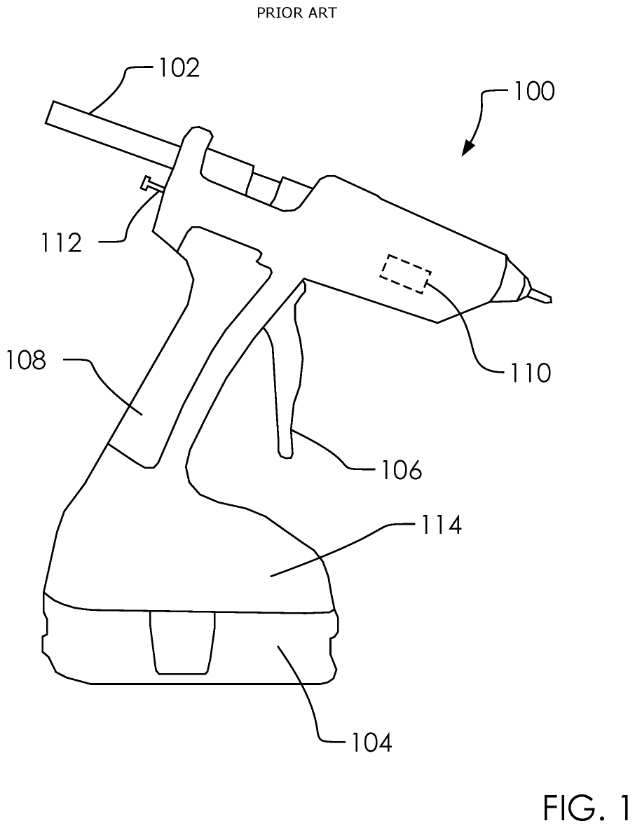

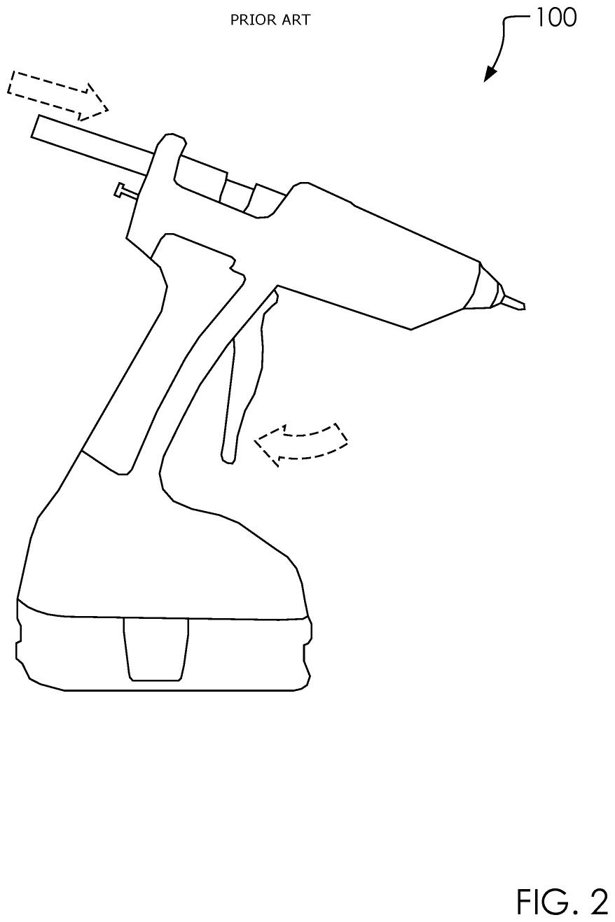

FIGS. 1-2 illustrate a prior art perspective view of a glue gun system 100.

In one embodiment, said glue gun system 100 can comprise a glue stick 102, a battery 104, a trigger 106, a base 114 and a handle 108. Said glue stick 102 is inserted into said glue gun system 100 and advanced through a heating element 110. Said handle 108 can support said glue gun system 100 in an upright position when not in use.

In one embodiment, said handle 108 can extend downward from a main housing of said glue gun system 100 and can be ergonomically shaped for user handling. Said trigger 106 can be operatively connected to a feeding mechanism to advance said glue stick 102 toward said heating element 110. Said heating element 110 can melt said glue stick 102 to facilitate controlled dispensing through a nozzle.

In one embodiment, said glue gun system 100 can further comprise a feed dial 112, which can extend from a rear portion of said glue gun system 100.

FIG. 2 illustrates another prior art perspective view of said glue gun system 100.

In one embodiment, said glue gun system 100 can be dimensioned and shaped similarly to commercially available glue guns, wherein said handle 108 and said trigger 106 operate together to feed said glue stick 102 through said heating element 110. Said battery 104 can be positioned in said base 114 so that said glue gun system 100 can remain upright when placed on a surface.

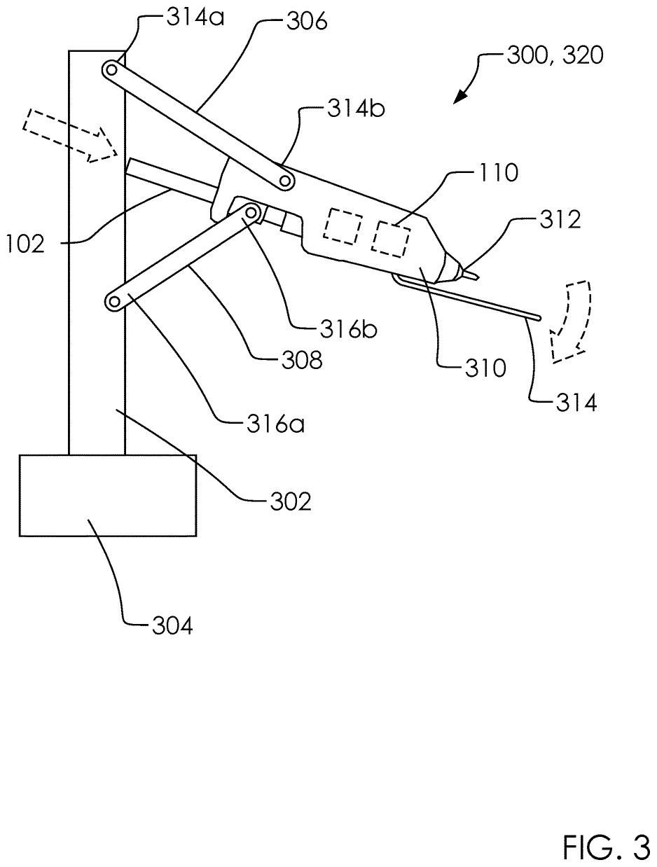

FIG. 3 illustrates a mounted glue dispenser 300 in a horizontal mount configuration 240.

In one embodiment, said mounted glue dispenser 300 can be secured to a vertical post 302, which can comprise a base 304 for stability. Said mounted glue dispenser 300 can include a body bracket 306, a pushing bracket 308, said glue stick 102, said heating element 110, a body 310, a nozzle 312, and a pushing lever 314. Said body bracket 306 can be rotatably mounted to said vertical post 302 at a first end 314a, and can also be rotatably connected to said body 310 at a second end 314b. Said pushing bracket 308 can comprise a first end 316a that is rotatably attached to said vertical post 302, and a second end 316b that is configured to push a portion of said glue stick 102. As said body 310 moves relative to said vertical post 302, said pushing bracket 308 can advance or retract said glue stick 102 toward said heating element 110.

In one embodiment, said pushing lever 314 can extend beyond said nozzle 312 and can be configured to transfer rotary torque onto said body 310. A user can press said pushing lever 314 while holding an item in front of said nozzle 312, allowing for one-handed operation. In one embodiment, said mounted glue dispenser 300 can be powered by an electrical supply or by a battery such as said battery 104, in conjunction with said heating element 110.

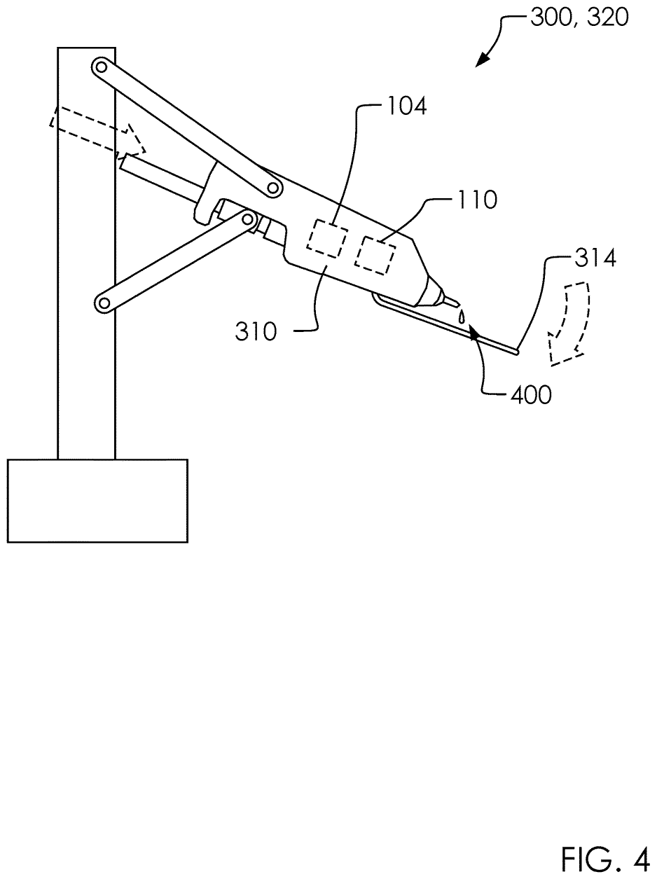

FIG. 4 illustrates an elevated side view of said mounted glue dispenser 300.

In one embodiment, said body 310 can be depressed downward by said pushing lever 314, thereby dispensing a liquefied glue 400 from said nozzle 312. When said pushing lever 314 is released, said pushing bracket 308 and associated internal components can reset to a position ready for further use.

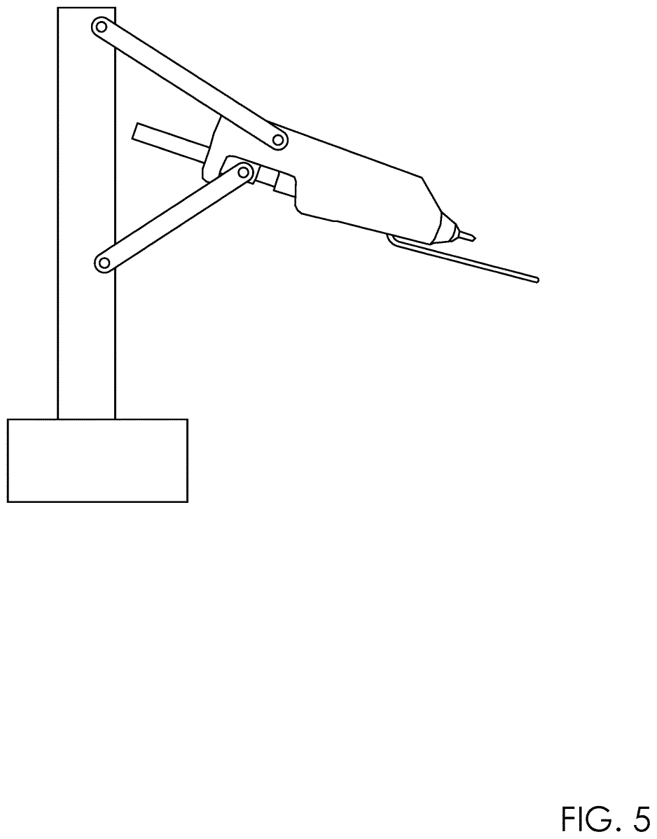

FIG. 5 illustrates another elevated side view of said mounted glue dispenser 300, showing the system reset and prepared for subsequent operation.

In one embodiment, said pushing bracket 308 can return to an initial position upon release of force from said pushing lever 314, allowing an operator to insert a fresh portion of said glue stick 102 as needed.

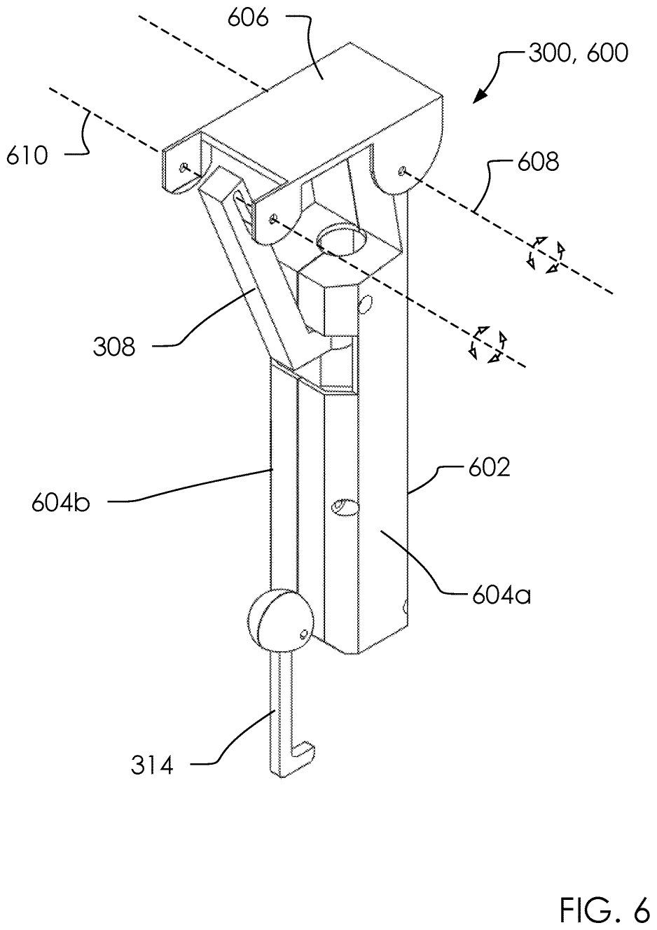

FIG. 6 illustrates a perspective overview of said mounted glue dispenser 300 in a vertical mount configuration 600.

In one embodiment, said mounted glue dispenser 300 can hang from an overhead surface 800. In this configuration, said mounted glue dispenser 300 can comprise a body shell 602 and a top mount 606. Said body shell 602 can include a first side 604a and a second side 604b, while a body rotating axis 608 can be formed through said body shell 602 and said top mount 606. Said top mount 606 can further comprise a pusher rotating axis 610 that can cooperate with said pushing bracket 308.

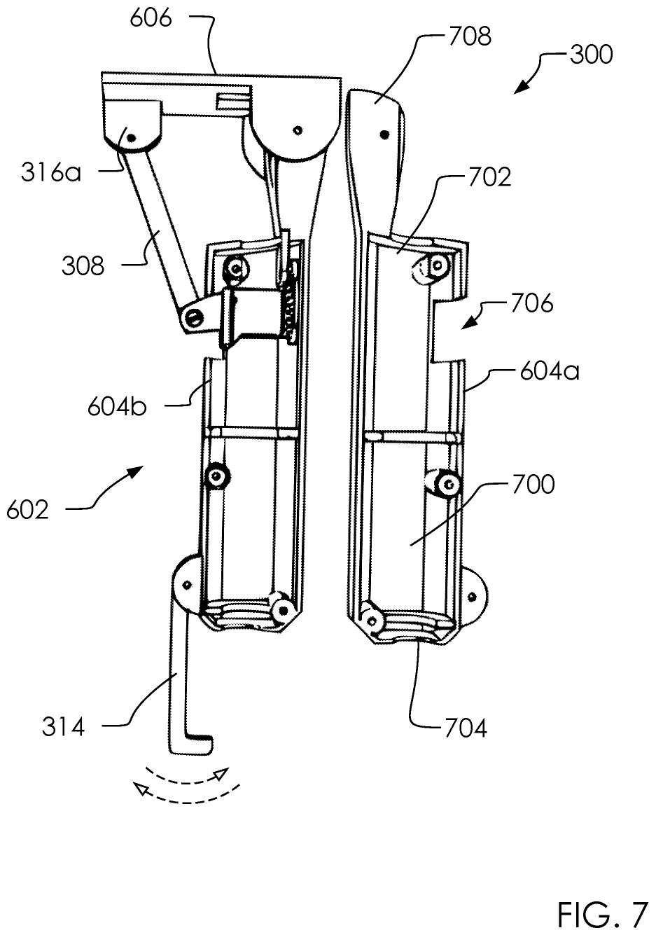

FIG. 7 illustrates a perspective view of said mounted glue dispenser 300 with said body shell 602 in a disassembled or broken-apart state.

In one embodiment, said body shell 602 can define an internal cavity 700 having a glue aperture 702, a nozzle aperture 704, and a pusher aperture 706. A rotating arm 708 can selectively attach to said top mount 606 around said body rotating axis 608. Said first end 316a of said pushing bracket 308 can rotatably attach to said pusher rotating axis 610, while said pushing lever 314 can attach to a portion of said body shell 602 near said nozzle aperture 704 and extend away from said top mount 606. Said pushing lever 314 can rotate in a plane aligned with said body rotating axis 608 and said pusher rotating axis 610.

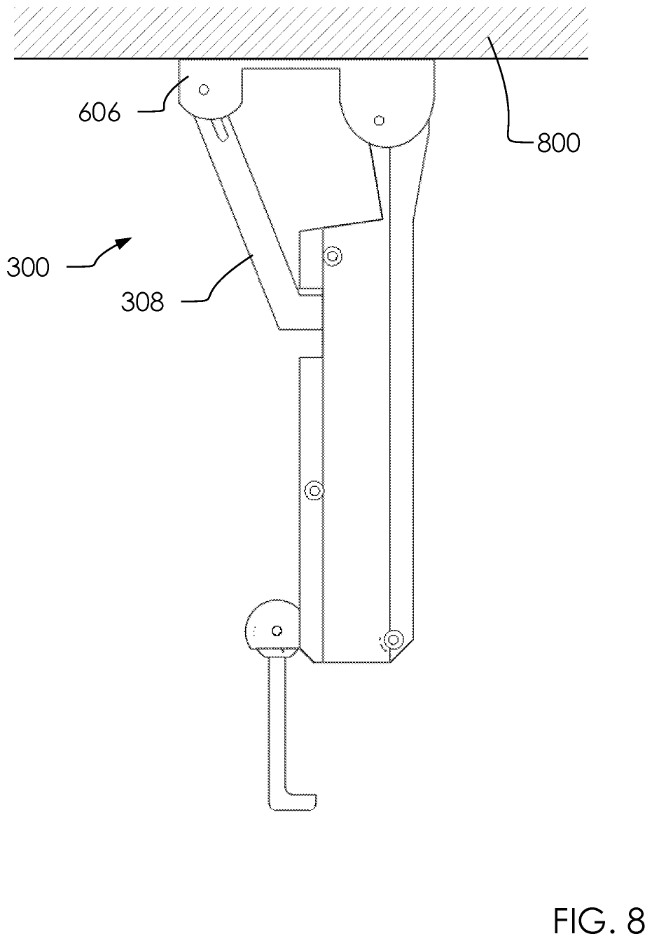

FIG. 8 illustrates an elevated side view of said mounted glue dispenser 300 and said vertical mount configuration 600.

In one embodiment, said top mount 606 can be adapted to attach to said overhead surface 800, allowing said body 310 to pivot in a manner that enables controlled dispensing of glue.

In one embodiment, top mount 606 can be bolted, screwed or nailed to overhead surface 800 using a fastener. In another embodiment, said top mount 606 can attach to said overhead surface 800 using magnets or other attaching means.

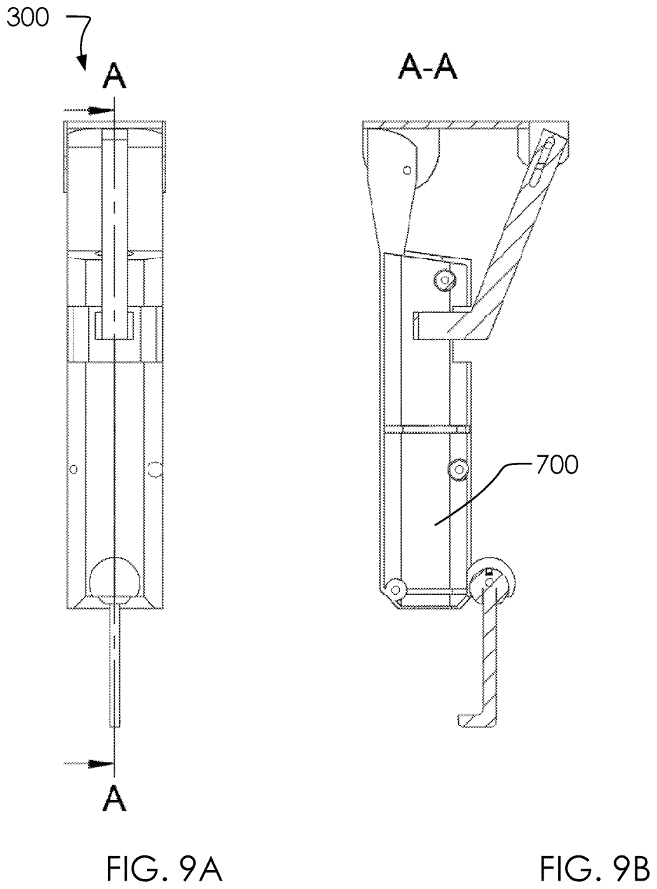

FIGS. 9A and 9B illustrate an elevated side view of said mounted glue dispenser 300, said vertical mount configuration 600, and a cross-sectional front view thereof.

In one embodiment, said body shell 602 can be shaped to accommodate internal components such as said heating element 110, said battery 104, or other power arrangements. The cross-sectional view can reveal how said pushing bracket 308 cooperates with the internal cavity 700 to advance said glue stick 102.

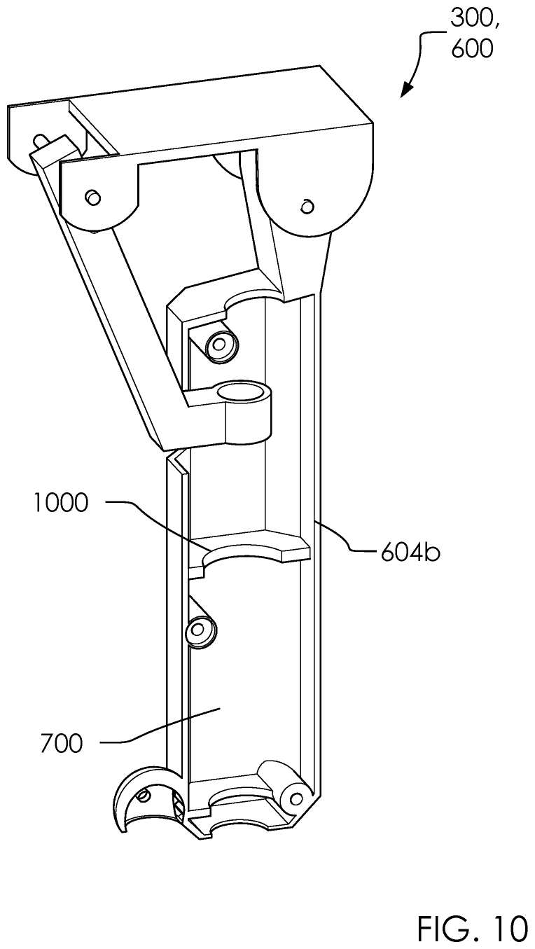

FIG. 10 illustrates said mounted glue dispenser 300 in said vertical mount configuration 600 with first side 604a removed to expose said internal cavity 700.

In one embodiment, said mounted glue dispenser 300 can further comprise an alignment bracket 1000 disposed within said internal cavity 700. Said mounted glue dispenser 300 can house an existing glue gun such as said glue gun system 100, or, alternatively, it can incorporate its own integrated heating and feeding components, including said battery 104, said heating element 110, portions of said glue stick 102, and said nozzle 312 within said body shell 602.

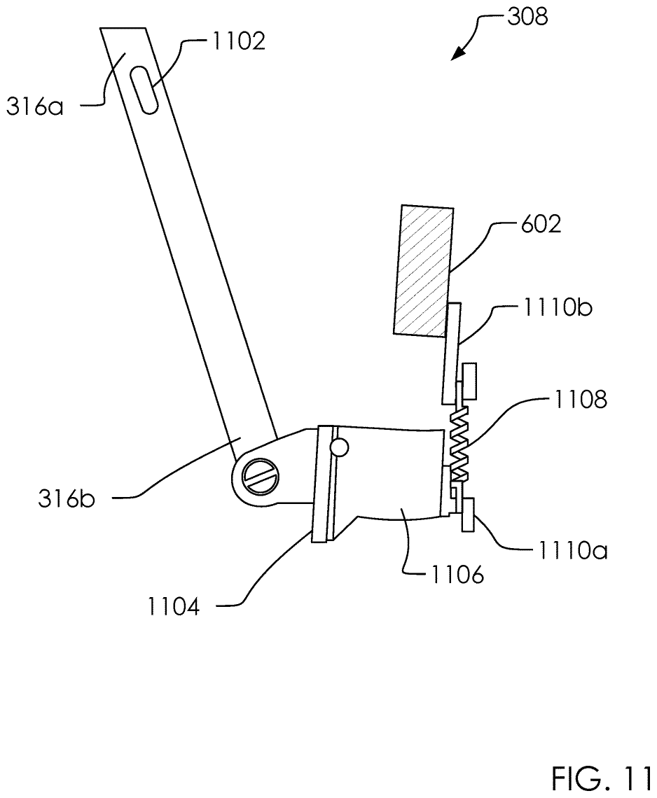

FIG. 11 illustrates a perspective overview of said pushing bracket 308.

In one embodiment, said pushing bracket 308 can comprise an upper aperture 1102 and a glue pusher assembly 1104. Said glue pusher assembly 1104 can be rotatably attached at said second end 316b of said pushing bracket 308, such that a user's application of force on said body 310 or said pushing lever 314 is transmitted to said glue pusher assembly 1104. Said glue pusher assembly 1104 can comprise a pusher ring 1106 and a spring assembly 1108, with said spring assembly 1108 configured to reset said pushing bracket 308 after a dispensing action. Said upper aperture 1102 can have an elliptical shape to allow portions of said top mount 606 or said body shell 602 to slide through and engage said pushing bracket 308 as needed for advancing said glue stick 102.

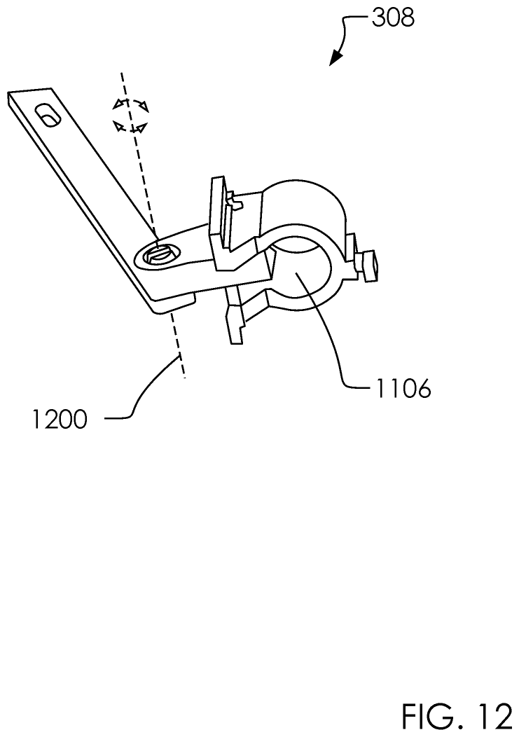

FIG. 12 illustrates a perspective lower view of said pushing bracket 308.

In one embodiment, said second end 316b of said pushing bracket 308 can be rotatably attached to said glue pusher assembly 1104 about a lower pusher axis 1200. This arrangement can facilitate an efficient transfer of force from said pushing lever 314 or said body 310 to said pushing bracket 308 for feeding said glue stick 102.

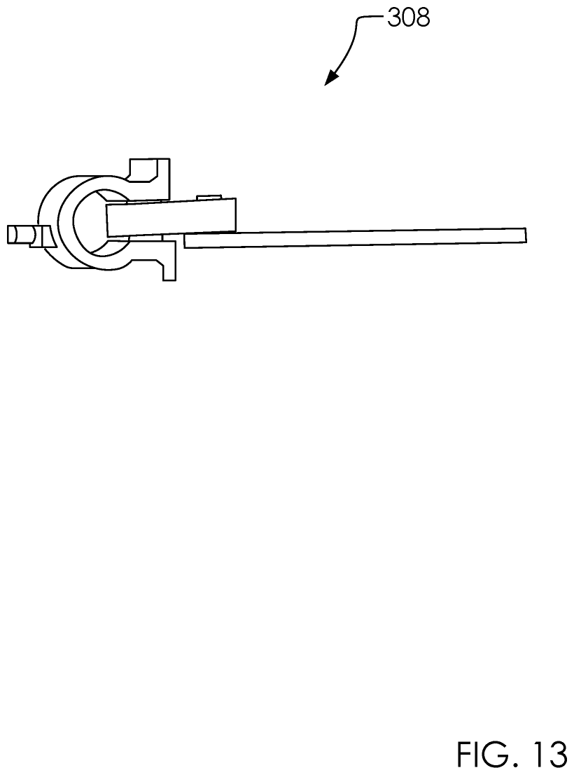

FIG. 13 illustrates an elevated top view of said pushing bracket 308.

In one embodiment, said top view highlights the relative positioning of said pusher ring 1106 and said spring assembly 1108, ensuring that said pushing bracket 308 can smoothly pivot around said lower pusher axis lower pusher axis 1200 while maintaining alignment with said glue stick 102 during repeated dispensing cycles.

In operation, the disclosed mounting configurations enable hands-free support of said mounted glue dispenser 300 on various surfaces, permitting a user to hold an item to be glued while actuating said pushing lever 314. The system can be adapted to operate with a rechargeable battery or an external power source, thereby providing versatility in a wide range of applications including paint-less dent repair, artistic endeavors, carpentry, and educational settings.

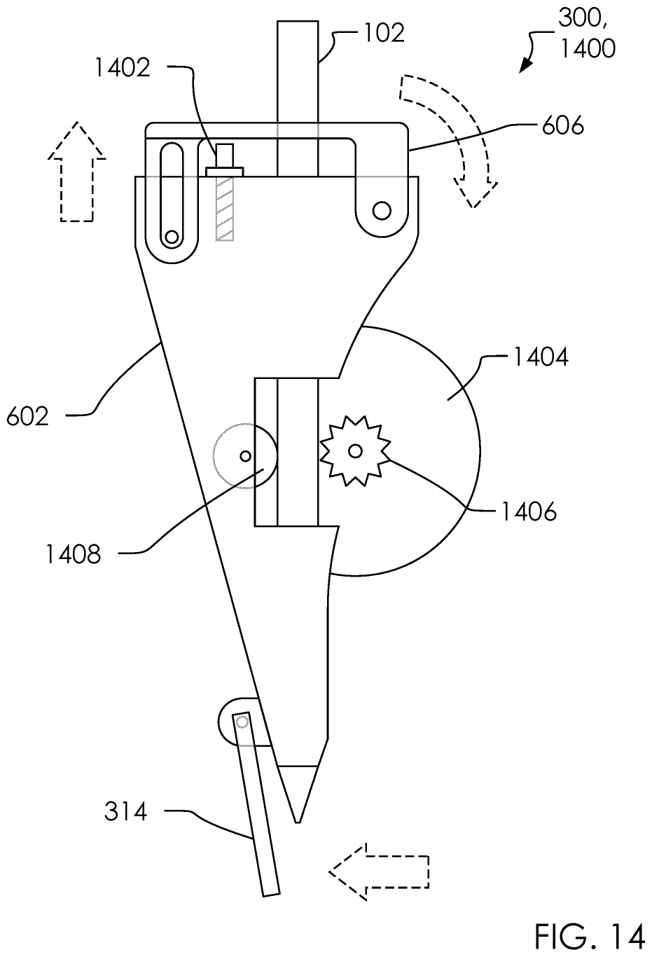

FIG. 14 illustrates an elevated side view of an electric switch configuration 1400 of said mounted glue dispenser 300.

In one embodiment, said electric switch configuration 1400 can comprise an activation switch 1402, an electric motor 1404, a barbed wheel 1406, and a roller 1408. These components can be arranged proximate said body shell 602 and said pushing lever 314, integrating with previously discussed elements such as said top mount 606 and said glue stick 102. Said barbed wheel 1406 can engage said glue stick 102 to advance it toward a heating region (e.g., said heating element 110). Said roller 1408 can help stabilize or guide said glue stick 102 during operation.

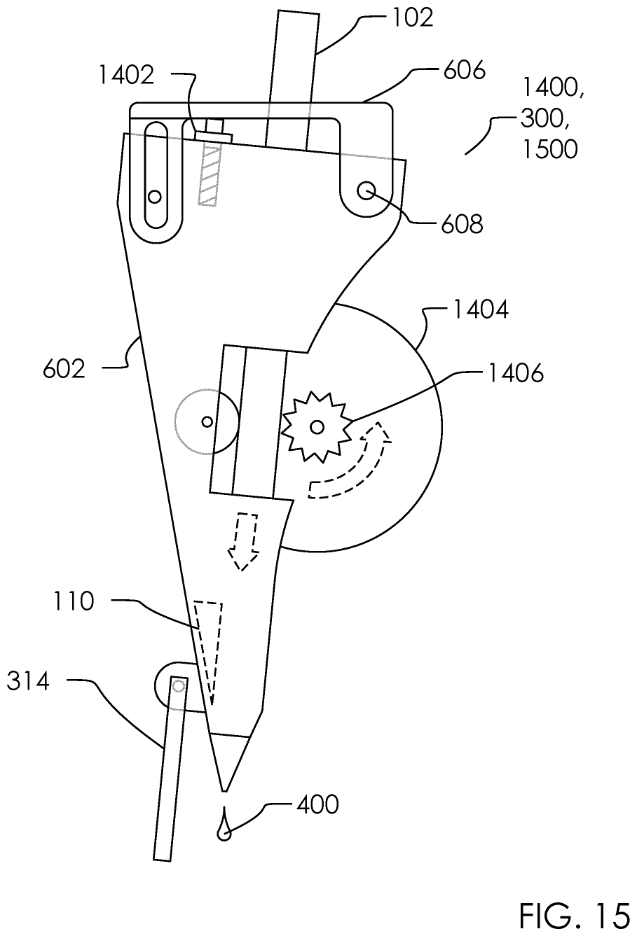

FIG. 15 illustrates said electric switch configuration 1400 in an activated configuration 1500.

In one embodiment, said body shell 602 can rotate about said body rotating axis 608, causing said activation switch 1402 to press into a portion of said top mount 606. This interaction can energize said electric motor 1404, which in turn rotates said barbed wheel 1406. As said barbed wheel 1406 turns, said glue stick 102 advances into said heating element 110, thereby melting a portion of said glue stick 102 into the liquefied glue 400. Because motor-driven advancement does not rely on the magnitude of manual trigger force, a more consistent or electronically metered dose of said liquefied glue 400 can be dispensed.

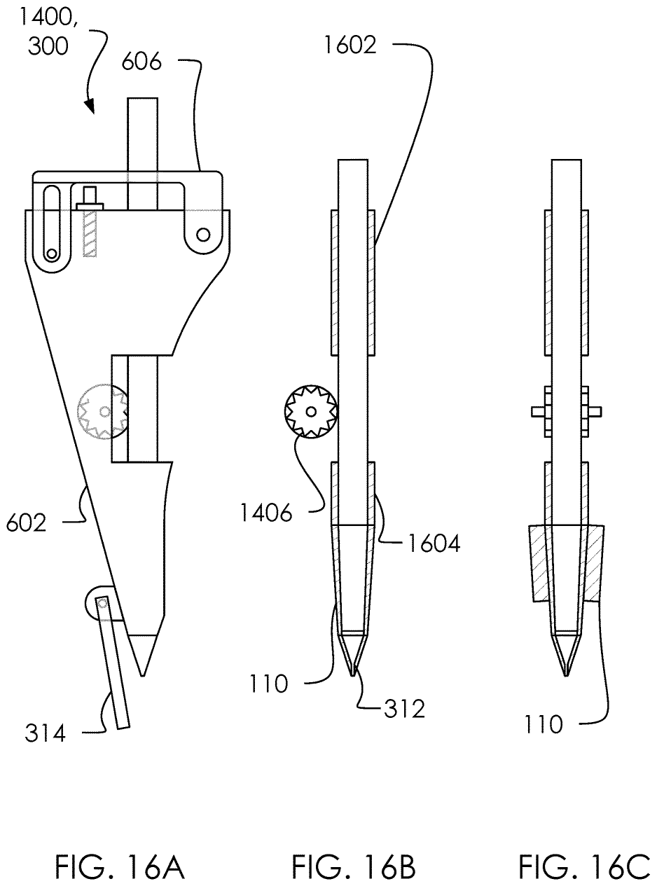

FIGS. 16A, 16B, and 16C illustrate three elevated views of portions of said electric switch configuration 1400 integrated into said mounted glue dispenser 300.

In one embodiment, said mounted glue dispenser 300 can comprise an upper glue channel 1602 and a lower glue channel 1604 that help align said glue stick 102 as it progresses toward said heating element 110.

FIGS. 16B and 16C depict variations where said body shell 602, said top mount 606, and said pushing lever 314 are removed or partially cut away to highlight interior features.

In operation, said glue stick 102 can pass from said upper glue channel 1602 into said lower glue channel 1604, eventually encountering said heating element 110 and said nozzle 312, through which said liquefied glue 400 is dispensed.

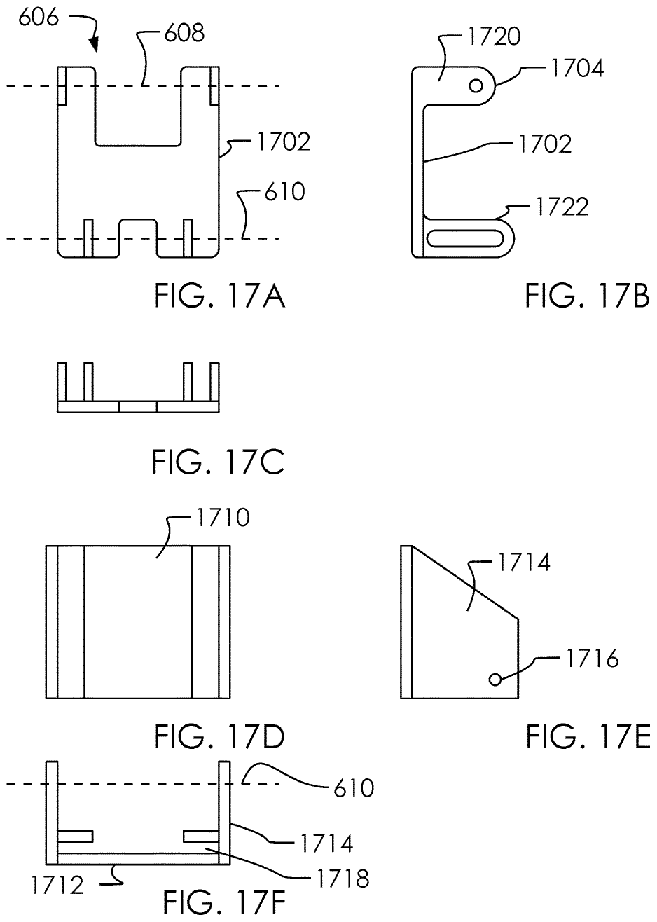

FIGS. 17A, 17B, and 17C illustrate three elevated views of said top mount 606.

In one embodiment, said top mount 606 can comprise a planar body 1702 and two or more axis extensions 1704. Said axis extensions 1704 can include two upper extensions 1720 and two lower extensions 1722. These can provide mounting points for the body rotating axis 608 and the pusher rotating axis 610, enabling rotation of said body shell 602 or attachment of said pushing bracket 308. Said axis extensions 1704 can project outward from said planar body 1702 so that said top mount 606 may interface with various components of said mounted glue dispenser 300 in different configurations.

FIGS. 17D, 17E, and 17F illustrate three elevated views of a mounting sleeve 1710.

In one embodiment, a portion of said top mount 606 can selectively slide within, and be secured by, said mounting sleeve 1710. Said mounting sleeve 1710 can comprise a backplate 1712 and two sides 1714, each of said sides 1714 including a mounting aperture 1716 arranged to align with said pusher rotating axis 610. A slot 1718 in said mounting sleeve 1710 can receive an edge or portion of said planar body 1702. In operation, said axis extensions 1704 can remain at least partially outside said mounting sleeve 1710, while said planar body 1702 slides inside, thereby allowing robust but removable mounting.

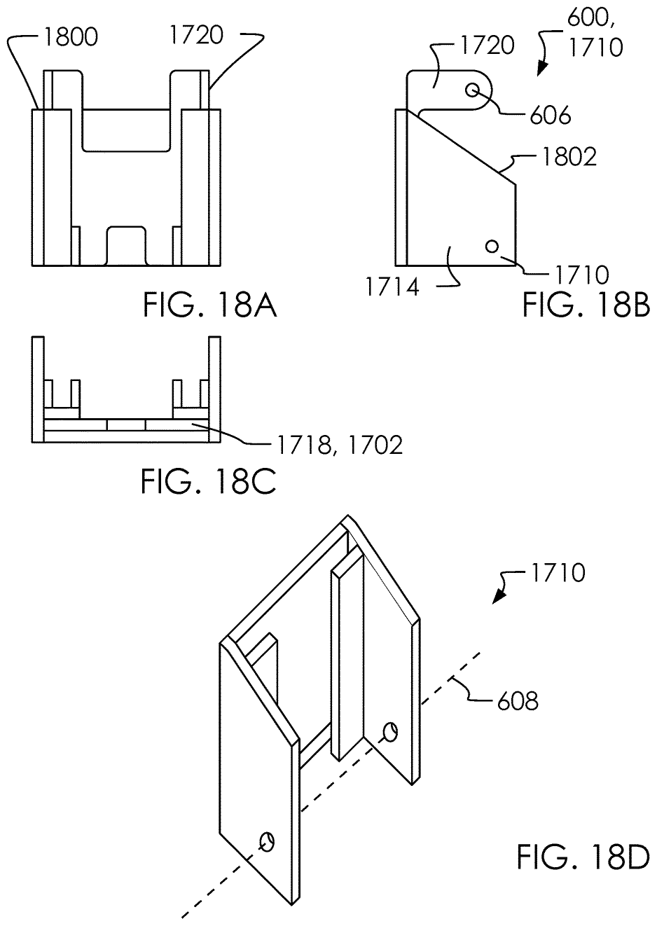

FIGS. 18A, 18B, 18C, and 18D illustrate various views of said top mount 606 inserted into portions of said mounting sleeve 1710, as well as an overview of said mounting sleeve 1710.

In one embodiment, said two upper extensions 1720 can rest upon an upper edge 1800 of said mounting sleeve 1710, while said planar body 1702 slides into said slot 1718. A tapered top edge 1802 of said sides 1714 can permit free movement of said two upper extensions 1720 and said body rotating axis 608 during operation, preventing obstruction of rotational or pivotal motions. Additionally, said lower extensions two lower extensions 1722 can pass within said mounting sleeve 1710 without interference, ensuring unimpeded rotation of said mounted glue dispenser 300.

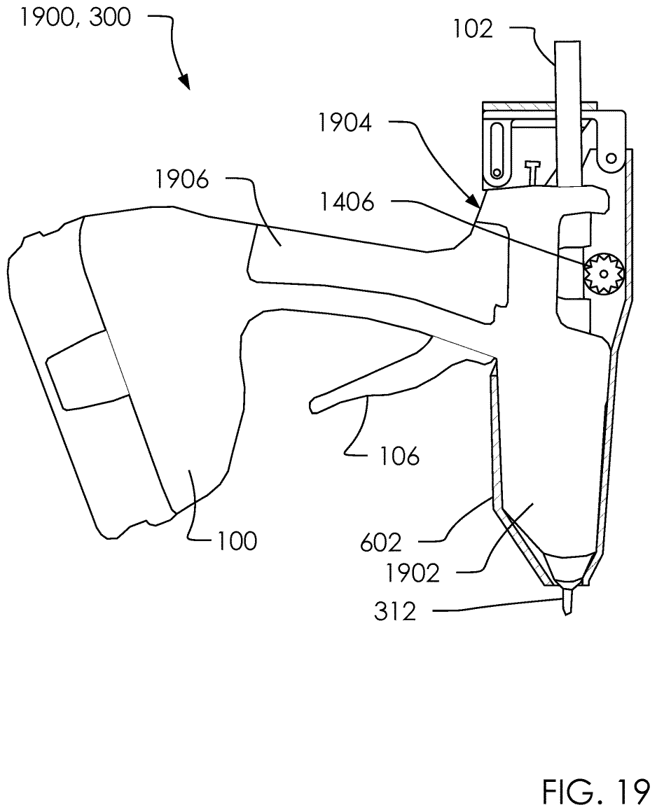

FIG. 19 illustrates a side view of a holster configuration 1900 of said mounted glue dispenser 300.

In one embodiment, said holster configuration 1900 can receive and hold a barrel portion 1902 of said glue gun system 100. A side gap 1904 can be formed in said body shell 602 to accommodate a grip portion 1906 of said glue gun system 100, permitting a user's existing glue gun to be inserted laterally while maintaining alignment of said glue stick 102, said heating element 110, and said nozzle 312. This approach can allow an end user to add advanced features of said mounted glue dispenser 300 to legacy glue guns without discarding prior investments.

This configuration can be used in conjunction with said pushing lever 314, although not illustrated here.

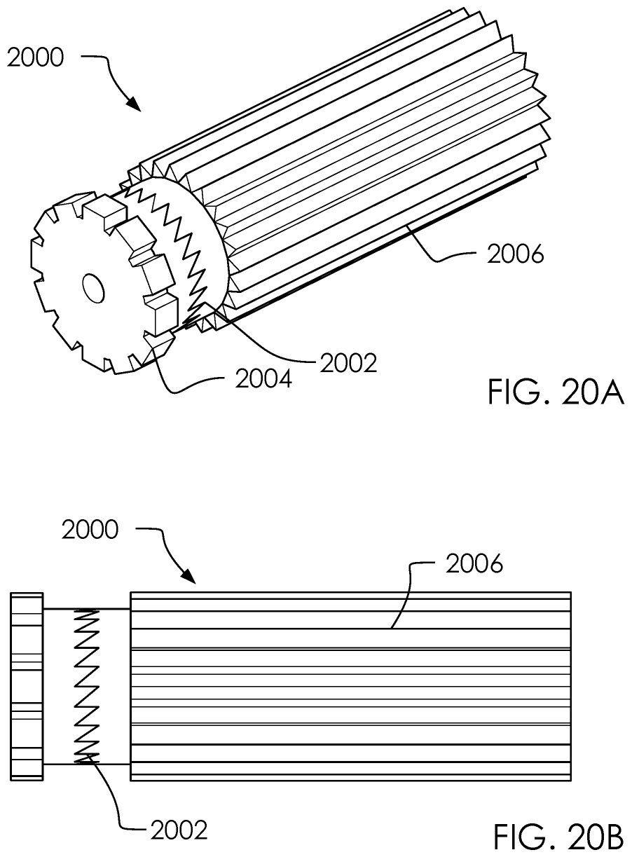

FIGS. 20A and 20B illustrate several views of a barbed clutch wheel assembly 2000.

In one embodiment, said barbed clutch wheel assembly 2000 can comprise a clutch 2002, a pinion gear 2004, and a barbed portion 2006. Said clutch 2002 can be configured to transmit rotational power from said electric motor 1404 (or a manual lever) to said pinion gear 2004 in only one direction, thereby inhibiting reverse motion of said glue stick 102.

In one embodiment, said barbed clutch wheel assembly 2000 can operate in conjunction with a spring that can bias said clutch 2002 to lock or release.

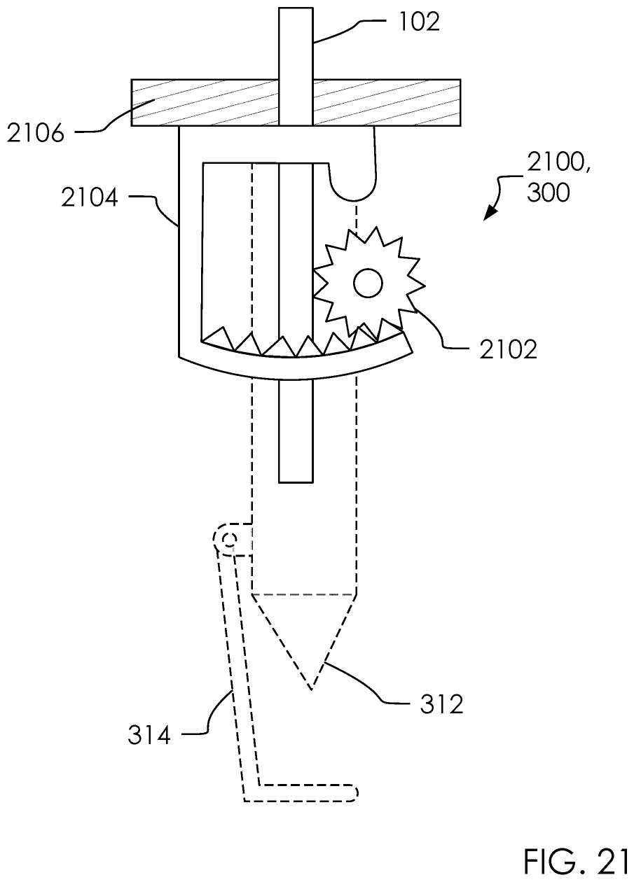

FIG. 21 illustrates a hand-drawn schematic of a manual advancement bracket 2100 of said mounted glue dispenser 300.

In one embodiment, said manual advancement bracket 2100 can comprise a manually engaged glue advancement barb wheel 2102 and an advancement tooth assembly 2104 mounted to a surface 2106. Pivoting said manual advancement bracket 2100 relative to said advancement tooth assembly 2104 can rotate said manually engaged glue advancement barb wheel 2102, thereby advancing said glue stick 102 toward said nozzle 312. Said clutch 2002 can prevent back-rotation of said manually engaged glue advancement barb wheel 2102, keeping said glue stick 102 from slipping rearward.

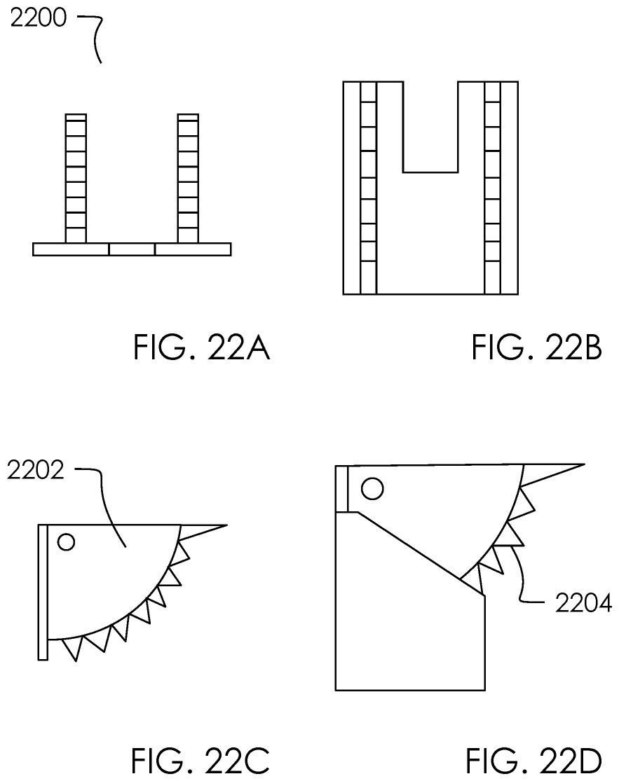

FIGS. 22A, 22B, 22C, and 22D illustrate an alternative configuration of said top mount 606 featuring a geared mount 2200.

In one embodiment, said geared mount 2200 can comprise a first gear assembly 2202 and a second gear assembly 2204, which can be housed within or behind said top mount 606. Manual or motorized rotation of said second gear assembly 2204 can impart motion to said manually engaged glue advancement barb wheel 2102. This compact gear arrangement can minimize external lever arms, improving durability and ease of use.

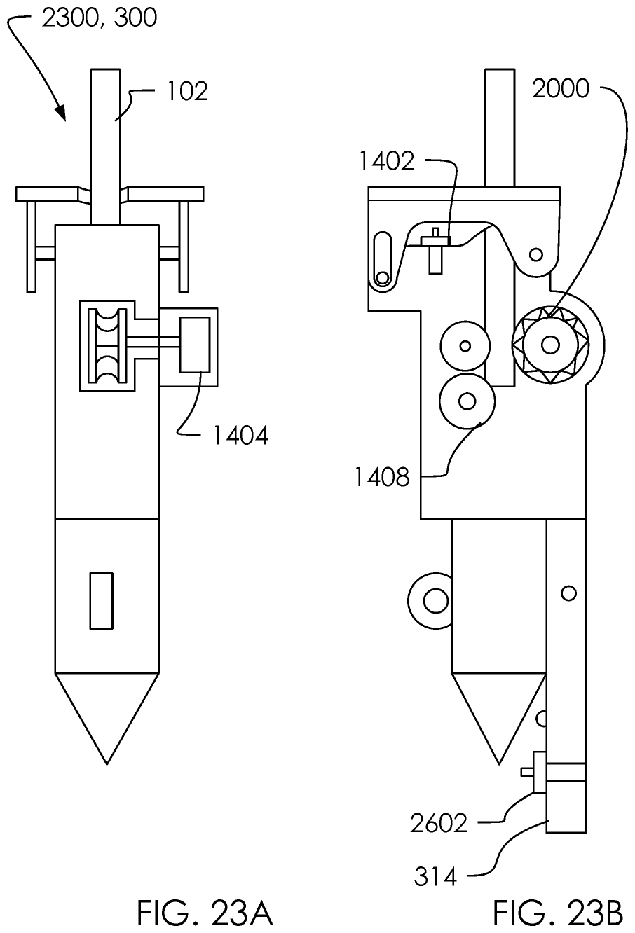

FIGS. 23A and 23B illustrate an elevated side view and a front view, respectively, of an electric switch configuration 2300 of said mounted glue dispenser 300.

In one embodiment, said electric switch configuration 2300 can be like said electric switch configuration 1400, featuring said electric motor 1404, said roller 1408, and said activation switch 1402. Here, said pushing lever 314 can comprise a lower electric switch 2302 that triggers power to advance said glue stick 102. Said barbed clutch wheel assembly 2000 or said electric switch configuration 2300 can receive torque from said electric motor 1404, feeding said glue stick 102 toward said nozzle 312.

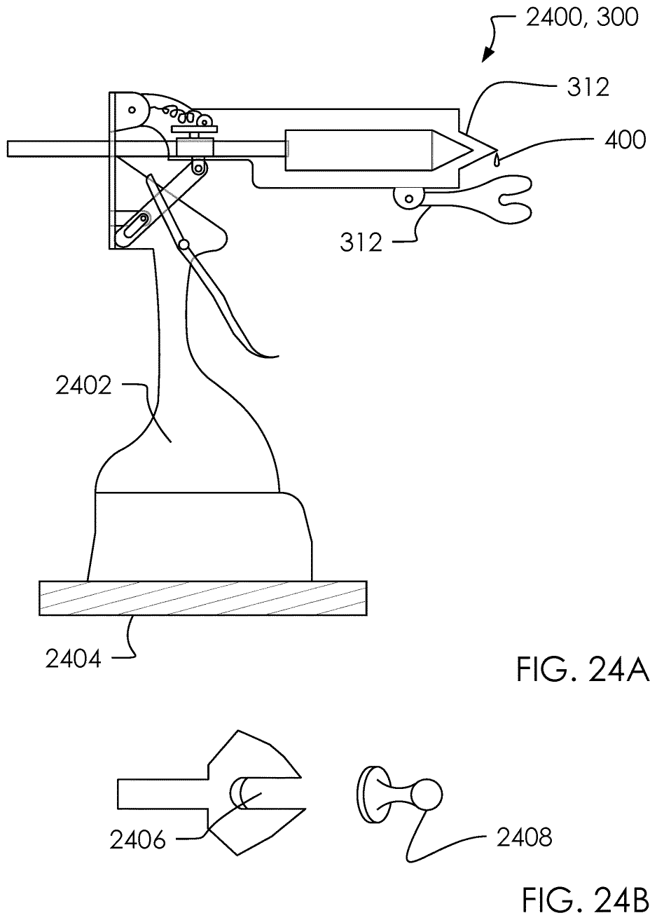

FIGS. 24A and 24B illustrate a standing version 2400 of said mounted glue dispenser 300 with a base 2402.

In one embodiment, said base 2402 can rest on a table or a support surface 2404, allowing said mounted glue dispenser 300 to operate in a freestanding mode. A variation of said pushing lever 314 can comprise an accessory slot 2406 in which a glue tab 2408 (not visible until later figure) can be inserted. In some use cases, said glue tab 2408 can be utilized in paintless dent repair, so that said liquefied glue 400 is dispensed directly onto said glue tab 2408 for bodywork applications.

The following describes a method of use for operating said glue gun system 100 or said mounted glue dispenser 300.

In one embodiment, said method of use can begin by: mounting the vertical post 302 to a support surface. Said vertical post 302 can be secured to a vertical wall surface, attached to an overhead surface using the top mount 606, or positioned on a horizontal surface using a freestanding base. The mounting configuration selected can depend on the specific application and workspace constraints of the user.

Further the method comprises positioning the body 310 having the heating element 110 and the nozzle 312, wherein said body 310 is pivotably coupled to said vertical post 302. This pivotable coupling can enable said body 310 to rotate about a pivot axis during actuation, as described in Claim 10. In embodiments utilizing said top mount 606, said body 310 can hang substantially vertically, while in embodiments using the vertical post 302, said body 310 can extend substantially horizontally from said vertical post 302.

Further the method comprises inserting the glue stick 102 into an internal channel of said body 310. Said glue stick 102 can be inserted from a rear portion of said body 310 and can extend through said internal channel toward said heating element 110. Once inserted, said glue stick 102 can be engaged by the pushing bracket 308 configured to feed said glue stick 102 through said internal channel during operation.

Further the method comprises selecting an actuation mode from among manual, electric, or wireless options. This decision point reflects the versatility of said mounted glue dispenser 300 in accommodating different power sources and user preferences.

If manual actuation is selected, the method further comprises applying manual force to the pushing lever 314. Said pushing lever 314 can extend beyond said nozzle 312 and can be configured to receive direct pressure from the user's hand or finger, thereby providing mechanical advantage for actuating said body 310, as set forth in Claim 6.

Alternatively, if electric actuation is selected, the method comprises activating the electric motor 1404 via said pushing lever 314. In this embodiment, pressing said pushing lever 314 can close an electrical circuit or activate a switch, thereby energizing said electric motor 1404 and driving said pushing bracket 308 through the barbed wheel 1406, as described in Claims 7 and 8.

In another embodiment, if wireless actuation is selected the method further comprises transmitting an activation signal from a wireless controller to a wireless receiver operatively connected to said electric motor 1404. This wireless capability can enable hands-free or remote operation of said mounted glue dispenser 300, as set forth in Claim 9 and Claim 15.

Regardless of the actuation mode selected, the method can converges, wherein said body 310 can pivot relative to said vertical post 302 in response to force applied to said pushing lever 314. This pivoting motion can be facilitated by the body bracket 306 or body rotating axis 608 that couple said body 310 to said vertical post 302, as described in Claim 10. The pivoting action can simultaneously actuate said pushing bracket 308.

Further the method comprises said pushing bracket 308 advancing said glue stick 102 through said internal channel toward said heating element 110. In embodiments employing the pushing bracket 308, pivoting of said body 310 can cause the second end 316b of said pushing bracket 308 to push against said glue stick 102, thereby advancing it forward, as described in Claim 11. In other embodiments utilizing the barbed clutch wheel assembly 2000, rotation of said barbed clutch wheel assembly 2000 can grip and incrementally advance said glue stick 102, as set forth in Claim 12.

Further the method comprises melting a portion of said glue stick 102 using that has been advanced into contact with or proximity to said heating element 110. Said heating element 110 can be powered by the battery 104, which can comprise a battery, AC power adapter, or other electrical supply. The melting process can convert the solid adhesive material into a flowable liquid state suitable for dispensing.

Further the method comprises dispensing the melted adhesive material through said nozzle 312 onto a target surface. The user can direct said nozzle 312 toward a workpiece, substrate, or other object requiring adhesive bonding. In one embodiment, the user can support the workpiece with both hands while said body 310 remains mounted to said vertical post 302, and can actuate said pushing lever 314 to dispense the melted adhesive material while continuing to support the workpiece, as described in Claim 17. This hands-free mounting capability can distinguish said mounted glue dispenser 300 from conventional handheld glue guns.

Further the method comprises including a decision point wherein the user determines whether to continue dispensing adhesive. If additional adhesive is required, the method proceeds to maintaining pressure on said pushing lever 314, thereby sustaining the advancement of said glue stick 102 and the dispensing of melted adhesive. The method then loops back to continue the advancement and dispensing cycle.

If no further adhesive is needed the method proceeds to releasing said pushing lever 314 and allow the system to reset. In embodiments employing a spring-loaded mechanism, releasing said pushing lever 314 can cause said body 310 to return to an initial position, and can disengage said pushing bracket 308 from said glue stick 102, thereby preventing unwanted adhesive flow and preparing said mounted glue dispenser 300 for subsequent operation.

In one embodiment, said method of use can be adapted for various mounting configurations by selecting an appropriate configuration. For instance, the user can choose to mount said vertical post 302 to a vertical wall surface in a horizontal configuration, mount said vertical post 302 to an overhead surface in a vertical configuration, or position said vertical post 302 on a horizontal surface using a freestanding base in a table-mounted configuration, as set forth in Claim 16. Each configuration can offer distinct ergonomic and operational advantages depending on the workspace and application requirements.

The method can provide a systematic approach to operating said mounted glue dispenser 300 across its various embodiments, encompassing manual, electric, and wireless actuation modes, multiple mounting configurations, and hands-free operation capabilities. This versatility can enable said mounted glue dispenser 300 to serve a wide range of adhesive application tasks in professional, hobbyist, and industrial settings.

### PARTS LIST

glue gun system 100,
glue stick 102,
battery 104,
trigger 106,
handle 108,
heating element 110,
feed dial 112,
base 114,
horizontal mount configuration 240,
mounted glue dispenser 300,
vertical post 302,
base 304,
body bracket 306,
pushing bracket 308,
body 310,
nozzle 312,
pushing lever 314,
first end 314a,
second end 314b,
first end 316a,
second end 316b,
liquefied glue 400,
vertical mount configuration 600,
body shell 602,
first side 604a,
second side 604b,
top mount 606,
body rotating axis 608,
pusher rotating axis 610,
internal cavity 700,
glue aperture 702,
nozzle aperture 704,
pusher aperture 706,
rotating arm 708,
overhead surface 800,
alignment bracket 1000,
upper aperture 1102,
glue pusher assembly 1104,
pusher ring 1106,
spring assembly 1108,
lower pusher axis 1200,
electric switch configuration 1400,
activation switch 1402,
electric motor 1404,
barbed wheel 1406,
roller 1408,
activated configuration 1500,
upper glue channel 1602,
lower glue channel 1604,
planar body 1702,
axis extensions 1704,
mounting sleeve 1710,
backplate 1712,
sides 1714,
mounting aperture 1716,
slot 1718,
two upper extensions 1720,
two lower extensions 1722,
upper edge 1800,
tapered top edge 1802,
holster configuration 1900,
barrel portion 1902,
side gap 1904,
grip portion 1906,
barbed clutch wheel assembly 2000,
clutch 2002,
pinion gear 2004,
barbed portion 2006,
manual advancement bracket 2100,
manually engaged glue advancement barb wheel 2102,
advancement tooth assembly 2104,
surface 2106,
geared mount 2200,
first gear assembly 2202,
second gear assembly 2204,
electric switch configuration 2300,
lower electric switch 2302,
standing version 2400,
base 2402,
support surface 2404,
accessory slot 2406, and
glue tab 2408.

One preferred embodiment can be found in the original claims to this application as outlined below.

The mounted glue dispenser 300 can comprise the vertical post 302 configured to support said system relative to a support surface. The body 310 pivotably coupled to said vertical post 302, said body 310 can comprise the heating element 110 configured to melt adhesive material, the nozzle 312 positioned to dispense melted adhesive material, and the internal cavity 700 extending from a rear portion to said nozzle 312 for receiving the glue stick 102. The pushing lever 314 operatively coupled to said body 310 and extending beyond said nozzle 312, said pushing lever 314 configured to provide mechanical advantage for actuating said body 310. The pushing bracket 308 operatively associated with said body 310 and configured to advance said glue stick 102 through said internal channel toward said heating element 110 in response to actuation of said pushing lever 314.

Said vertical post 302 can be configured to orient said body 310 in a substantially horizontal configuration extending outward from a vertical support surface.

Said vertical post 302 comprises the top mount 606 configured to suspend said body 310 in a substantially vertical configuration extending downward from the overhead surface 800.

Said vertical post 302 comprises the freestanding base configured to support said system in a table-mounted configuration.

Said pushing lever 314 comprises a lever arm extending from said body 310, said lever arm configured to transfer rotational force to said body 310 about a pivot axis.

Said pushing lever 314 can be configured for manual activation by a user applying pressure to said pushing lever 314.

An electric motor 1404 operatively coupled to said pushing bracket 308. The battery 104 electrically connected to said electric motor 1404, wherein activation of said pushing lever 314 actuates said electric motor 1404 to drive said pushing bracket 308.

The barbed wheel 1406 operatively coupling said electric motor 1404 to said pushing bracket 308, said barbed wheel 1406 configured to provide mechanical advantage for advancing said glue stick 102.

The wireless controller configured to remotely activate said electric motor 1404. the wireless receiver operatively connected to said electric motor 1404 and configured to receive activation signals from said wireless controller.

Said vertical post 302 comprises the vertical post 302. Said body 310 can be pivotably coupled to said vertical post 302 via the body bracket 306. Actuation of said pushing lever 314 causes said body 310 to pivot relative to said vertical post 302.

Said pushing bracket 308 comprises the pushing bracket 308 having the first end 316a pivotably coupled to said vertical post 302 and the second end 316b configured to engage said glue stick 102. A <linking element> operatively connecting said pushing bracket 308 to said pushing lever 314, wherein actuation of said pushing lever 314 causes said second end 316b to advance said glue stick 102 through said internal channel.

Said pushing bracket 308 comprises: the barbed clutch wheel assembly 2000 having the barbed portion 2006 configured to engage said glue stick 102. A biasing element 2008 configured to bias said barbed clutch wheel assembly 2000 into engagement with said glue stick 102, wherein rotation of said barbed clutch wheel assembly 2000 advances said glue stick 102 through said internal channel.

The method of use of dispensing adhesive material using the mounted glue dispenser 300 can comprise mounting the vertical post 302 to a support surface. Positioning the body 310 having the heating element 110 and the nozzle 312, wherein said body 310 can be pivotably coupled to said vertical post 302. Inserting the glue stick 102 into the internal cavity 700 of said body 310. Applying force to the pushing lever 314 extending from said body 310. Pivoting said body 310 relative to said vertical post 302 in response to said force applied to said pushing lever 314. Advancing said glue stick 102 through said internal channel toward said heating element 110 using the pushing bracket 308 actuated by movement of said pushing lever 314. Melting a portion of said glue stick 102 with said heating element 110. Dispensing melted adhesive material through said nozzle 312 onto a target surface.

Activating the electric motor 1404 in response to said force applied to said pushing lever 314. Driving said pushing bracket 308 with said electric motor 1404 to advance said glue stick 102.

Transmitting an activation signal from the wireless controller to the wireless receiver operatively connected to said electric motor 1404. Activating said electric motor 1404 in response to receiving said activation signal.

Mounting said vertical post 302 to a vertical wall surface in a horizontal configuration. Mounting said vertical post 302 to an overhead surface in a vertical configuration. Positioning said vertical post 302 on a horizontal surface using a freestanding base in a table-mounted configuration.

Supporting a workpiece with both hands while said body 310 can be mounted to said vertical post 302. Actuating said pushing lever 314 to dispense said melted adhesive material onto said workpiece while continuing to support said workpiece with both hands.

The mounted glue dispenser 300 can comprise the vertical post 302 configured to interface with a support surface. The body 310 coupled to said vertical post 302, said body 310 can comprise the heating element 110 for melting solid adhesive material, the nozzle 312 in fluid communication with said heating element 110, and a feed pathway extending from a receiving end to said heating element 110. the pushing lever 314 mechanically coupled to said body 310 and positioned to extend beyond said nozzle 312, said pushing lever 314 configured to impart movement to said body 310 relative to said vertical post 302. the pushing bracket 308 operatively coupled to said body 310 and configured to advance solid adhesive material through said feed pathway toward said heating element 110 in coordination with actuation of said pushing lever 314.

Said vertical post 302 comprises the vertical post 302. Said body 310 can be pivotably coupled to said vertical post 302 and houses said heating element 110, said nozzle 312, and the body shell 602. Said pushing lever 314 extends from said body 310 as an articulator providing mechanical advantage.

Said pushing bracket 308 can be configured to operate using one mode selected from the group consisting of: manual mechanical leverage transmitted through the pushing bracket 308. Electric motor drive using the electric motor 1404 with the barbed wheel 1406. Combined mechanical-electric operation using both manual and powered advancement.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A mounted glue dispenser, comprising:
a vertical post configured to support said system relative to a support surface;
a body pivotably coupled to said vertical post, said body comprising:
a heating element configured to melt adhesive material,
a nozzle positioned to dispense melted adhesive material, and
an internal cavity extending from a rear portion to said nozzle for receiving a glue stick;
a pushing lever operatively coupled to said body and extending beyond said nozzle, said pushing lever configured to provide mechanical advantage for actuating said body; and
a pushing bracket operatively associated with said body and configured to advance said glue stick through said internal channel toward said heating element in response to actuation of said pushing lever.

2. The mounted glue dispenser of claim 1, wherein,
said vertical post is configured to orient said body in a substantially horizontal configuration extending outward from a vertical support surface.

3. The mounted glue dispenser of claim 1, wherein,
said vertical post comprises a top mount configured to suspend said body in a substantially vertical configuration extending downward from an overhead surface.

4. The mounted glue dispenser of claim 1, wherein,
said vertical post comprises a freestanding base configured to support said system in a table-mounted configuration.

5. The mounted glue dispenser of claim 1, wherein,
said pushing lever comprises a lever arm extending from said body, said lever arm configured to transfer rotational force to said body about a pivot axis.

6. The mounted glue dispenser of claim 1, wherein,
said pushing lever is configured for manual activation by a user applying pressure to said pushing lever.

7. The mounted glue dispenser of claim 1, further comprising:
an electric motor operatively coupled to said pushing bracket; and
a battery electrically connected to said electric motor,
wherein activation of said pushing lever actuates said electric motor to drive said pushing bracket.

8. The mounted glue dispenser of claim 7, further comprising:
a barbed wheel operatively coupling said electric motor to said pushing bracket, said barbed wheel configured to provide mechanical advantage for advancing said glue stick.

9. The mounted glue dispenser of claim 7, further comprising:
a wireless controller configured to remotely activate said electric motor; and
a wireless receiver operatively connected to said electric motor and configured to receive activation signals from said wireless controller.

10. The mounted glue dispenser of claim 1, wherein,
said vertical post comprises the vertical post;
said body is pivotably coupled to said vertical post via a body bracket; and
actuation of said pushing lever causes said body to pivot relative to said vertical post.

11. The mounted glue dispenser of claim 1, wherein,
said pushing bracket comprises the pushing bracket having a first end pivotably coupled to said vertical post and a second end configured to engage said glue stick; and
a linking element operatively connecting said pushing bracket to said pushing lever,
wherein actuation of said pushing lever causes said second end to advance said glue stick through said internal channel.

12. The mounted glue dispenser of claim 1, wherein,
said pushing bracket comprises:
a barbed clutch wheel assembly having a barbed portion configured to engage said glue stick; and
a biasing element configured to bias said barbed clutch wheel assembly into engagement with said glue stick,
wherein rotation of said barbed clutch wheel assembly advances said glue stick through said internal channel.

13. A method of use of dispensing adhesive material using a mounted glue dispenser, comprising:
mounting a vertical post to a support surface;
positioning a body having a heating element and a nozzle, wherein said body is pivotably coupled to said vertical post;
inserting a glue stick into an internal cavity of said body;
applying force to a pushing lever extending from said body;
pivoting said body relative to said vertical post in response to said force applied to said pushing lever;
advancing said glue stick through said internal channel toward said heating element using a pushing bracket actuated by movement of said pushing lever;
melting a portion of said glue stick with said heating element; and
dispensing melted adhesive material through said nozzle onto a target surface.

14. The method of use of said mounted glue dispenser of claim 13, wherein, said advancing step comprises:
activating an electric motor in response to said force applied to said pushing lever; and
driving said pushing bracket with said electric motor to advance said glue stick.

15. The method of use of said mounted glue dispenser of claim 14, wherein, said activating step comprises:
transmitting an activation signal from a wireless controller to a wireless receiver operatively connected to said electric motor; and
activating said electric motor in response to receiving said activation signal.

16. The method of use of said mounted glue dispenser of claim 13, wherein, said mounting step comprises selecting one configuration from the group consisting of:
mounting said vertical post to a vertical wall surface in a horizontal configuration;
mounting said vertical post to an overhead surface in a vertical configuration; and
positioning said vertical post on a horizontal surface using a freestanding base in a table-mounted configuration.

17. The method of use of said mounted glue dispenser of claim 13, further comprising:
supporting a workpiece with both hands while said body is mounted to said vertical post; and
actuating said pushing lever to dispense said melted adhesive material onto said workpiece while continuing to support said workpiece with both hands.

18. A mounted glue dispenser, comprising:
a vertical post configured to interface with a support surface;
a body coupled to said vertical post, said body comprising:
a heating element for melting solid adhesive material,
a nozzle in fluid communication with said heating element, and
a feed pathway extending from a receiving end to said heating element;
a pushing lever mechanically coupled to said body and positioned to extend beyond said nozzle, said pushing lever configured to impart movement to said body relative to said vertical post; and
a pushing bracket operatively coupled to said body and configured to advance solid adhesive material through said feed pathway toward said heating element in coordination with actuation of said pushing lever.

19. The mounted glue dispenser of claim 18, wherein,
said vertical post comprises the vertical post;
said body is pivotably coupled to said vertical post and houses said heating element, said nozzle, and a body shell; and
said pushing lever extends from said body as an articulator providing mechanical advantage.

20. The mounted glue dispenser of claim 18, wherein,
said pushing bracket is configured to operate using one mode selected from the group consisting of:
manual mechanical leverage transmitted through the pushing bracket;
electric motor drive using an electric motor with a barbed wheel; and
combined mechanical-electric operation using both manual and powered advancement.
